(19) United States
(12) Patent Application Publication
(10) Pub. No.: US 2025/0368477 A1
(43) Pub. Date: Dec. 4, 2025

(54) Method for collision monitoring of a cable-guided load

(71) Applicant: Liebherr-Werk Nenzing GmbH, Nenzing (AT)

(72) Inventors: Nicola SCHLATTER, Nenzing (AT); Andreas KREUTZ, Schlins (AT)

(21) Appl. No.: 19/221,332

(22) Filed: May 28, 2025

(30) Foreign Application Priority Data
May 28, 2024 (DE) 10 2024 114 913.2

(51) Int. Cl. B66C 15/04; B66C 13/16; B66C 15/06; B66D 5/18

(52) U.S. Cl. CPC B66C 15/045; B66C 13/16; B66C 15/065; B66D 5/18

(57) ABSTRACT

The invention relates to a method for collision monitoring of a load which is fastened to a cable of a work machine, in particular a crane, wherein the work machine has a turntable that is rotatable about a vertical axis of rotation, a jib which is connected to the turntable and over which the cable is guided, and at least one sensor for detecting a current position and/or movement of at least one movable component of the work machine. According to the invention, a predicted braking trajectory of a defined point of the work machine is determined based on the sensor data, and a predicted braking trajectory of the load is calculated on the basis of the determined braking trajectory of the defined point and a computational model. The invention further relates to a work machine, in particular a crane, comprising a turntable that is rotatable about a vertical axis of rotation, a jib which is connected to the turntable and over which a cable is guided, and a control unit which receives data relating to a current position and/or movement of a load suspended on the cable, from at least one sensor of the work machine, wherein the control unit is configured to carry out the method according to the invention. The invention further relates to a corresponding computer program product.

### CROSS REFERENCE TO RELATED APPLICATION

The present application claims priority to German Patent Application No. 10 2024 114 913.2 filed on May 28, 2024. The entire contents of the above-listed application are hereby incorporated by reference for all purposes.

### TECHNICAL FIELD

The present invention relates to a method for collision monitoring of a load, a work machine, and a computer program product according each having the features described herein.

### BACKGROUND

Methods for collision monitoring of work machines are known from the prior art. In this case, typically a collision of the components of the work machine, such as a cable-guiding jib, with objects in the environment of the work machine is monitored. For this purpose, a plurality of sensors and/or cameras can be arranged on the work machine.

### SUMMARY

In the case of work machines with cable-guided loads or tools (referred to collectively in the following as loads), highly dynamic handling or movement processes result. If the work machine has to be braked abruptly during a movement process, swinging of the load occurs during the braking and also still after the movement has stopped. Owing to the usually very long braking paths in such work machines and the often considerable cable lengths, the loads can move, due to the swinging movements, in a significant range around their nominal position, which constitutes a considerable risk of collision. This dynamic behaviour is a challenge for the operator of the work machine, who must simultaneously be aware of changes in the working environment of the machine. The associated increased burden can lead to errors. If a collision occurs, this can lead to a standstill of the work process, which results in costs. Furthermore, damage to the work machine and endangerment of human personnel may occur.

The object of the present invention is therefore that of reducing the risk of collisions when working with cable-guided loads.

According to the invention, this object is achieved by a method having the features described herein, by a work machine having the features described herein, and by a computer program product having the features described herein. Advantageous embodiments of the invention will emerge from the following description.

According thereto, a method for collision monitoring of a load fastened to a cable of a work machine is proposed. In general, all work machines with which loads are movable via a cable are possible for the method. This can for example be a stationary or mobile crane, for example a harbour crane for handling containers or other goods.

The work machine comprises a turntable that is rotatable about a vertical axis of rotation, and a jib which is connected to the turntable and over which the cable is guided. The term “turntable” is to be interpreted broadly and can refer to any rotatable structure of a work machine, for example the upper structure of a mobile crane, a harbour crane or a cable dredger, or a rotatable upper construction of a stationary rotating tower crane. The jib can be immovably connected to the turntable and for example be permanently horizontally oriented or also connected to the turntable such that it can be moved, in particular luffed. It can for example be a lattice jib or a telescopic jib.

The work machine comprises at least one sensor for detecting a current position and/or a current movement (this can be a current speed and/or a current acceleration) of at least one component of the work machine. The sensor data are preferably received by a control unit of the work machine which carries out the collision monitoring method.

In the present case, a movable component can be understood to be any movable part of the work machine, for example the turntable, the jib, a luffing tip, but also a transmission or a drive. Thus, for example, the current position and/or movement of the turntable can be determined from the current position and/or movement of a rotary drive of said turntable. The same applies for a luffing cylinder of the jib or any other drive, and for transmissions. In the case of a mobile work machine, the movable component can also be a movable undercarriage.

According to the invention, a predicted, i.e. projected, braking trajectory of a defined point of the work machine is determined based on the data of the at least one sensor. The braking trajectory is the movement path of the defined point which said point describes during braking of a current movement up to standstill. The defined point can be any point of the work machine, preferably a defined point on the jib. The predicted braking trajectory is then the projected braking trajectory which would result if the current movement of the work machine is braked in a controlled manner (e.g. stopping of all the involved drives and/or actuation of all the brakes available or relevant for the respective movement process, in particular with maximum braking force), wherein for this purpose preferably a particular reaction time between a stop signal or a decision to stop the movement, and the start of the braking process, is assumed.

However, the predicted braking trajectory of the defined point would only allow collision monitoring of the machine components, for example of the jib. The dynamic behaviour of the load would not be taken into account in this case. Precisely in the case of abrupt braking, however, typically a significant swinging movement of the load occurs. For this reason, according to the invention, in a further step a predicted braking trajectory of the load is calculated based on the previously determined predicted braking trajectory of the defined point and additionally on the basis of a computational model which models the dynamic behaviour of the load or of the cable.

The method according to the invention makes it possible to determine at any time, for a given movement of the work machine, how the load would behave if a braking process should take place. This allows for significantly more reliable collision monitoring and prevention than if only the rigid components of the work machine were taken into account.

The method according to the invention can preferably be used in an assistance system in order to notify the operator of the work machine early of possible collisions, and thus to reduce the risk of collisions. Alternatively or in addition, the method according to the invention can be part of fully autonomous control of the work machine, in which all movements and also all the braking processes are performed by a control unit.

The method according to the invention can be combined with conventional methods of collision monitoring. Thus, for example, one or more cameras could be installed at at least one suitable position on the work machine, in order to detect the environment of the work machine and identify a collision of the work machine with obstacles in the environment early and optionally be able to take suitable countermeasures (e.g. outputting a warning and/or changing or stopping a current movement).

The predicted braking trajectory of the defined point depends on the current position of the work machine and can furthermore depend on a current speed and/or acceleration of one or more moving components of the work machine. If, for example, the turntable is rotated at a higher angular speed, the braking path increases or the predicted braking trajectory of the defined point lengthens.

In a possible embodiment, it is provided that the defined point is a point on the jib, in particular a cable starting point on a jib head. The cable starting point can be a point on the jib from which the cable hangs down, i.e. on which the cable leaves a guide or deflection roller of the jib and extends to the load. The trajectory of the cable starting point therefore determines the behaviour of the load. In this case, the predicted braking trajectory of the cable starting point can result from the movements of a plurality of units or movable components of the work machine, for example a rotational movement of the turntable and/or a pivoting movement of the jib, and optionally a travel movement of the entire work machine.

In a further possible embodiment it is provided that the predicted braking trajectory of the defined point is determined on the basis of at least one predicted braking trajectory of a movable component of the work machine. This can for example be a predicted braking trajectory of the turntable (rotational movement) or of the jib (pivot movement) or corresponding transmissions/drives.

Since the movement of the defined point can be made up of a plurality of individual movements (e.g. simultaneous rotation of the turntable and pivoting of the jib), the predicted braking trajectory of the defined point can optionally also be determined on the basis of a combination of at least two predicted braking trajectories of different movable components of the work machine.

It can be provided that each movable component involved in the movement of the defined point is modelled by its own unit model.

Preferably, for determining the predicted braking trajectory of a movable component, data stored in a memory unit or control unit are used. These can relate to a geometry, a mass, or another property of the movable component and/or a braking device braking the component.

Preferably, for determining the predicted braking trajectory of a movable component, the way in which a controller reduces the target speed of the movable component (or of the at least one actuator driving the movable component) is taken into account. This takes place in particular on the basis of a defined braking function which is taken into account when determining the predicted braking trajectory of the movable component. Preferably a braking function of this kind exists for each movable component involved in the movement of the defined point.

Preferably, for determining the predicted braking trajectory of a movable component, an actual position and/or actual speed and/or actual acceleration of the movable component or of the actuator driving it, acquired by sensors, is taken into account. For example, the actual position and the actual speed could form the basis together.

In a further possible embodiment it is provided that the predicted braking trajectory of the defined point is determined on the basis of a kinematic model of the work machine, in particular on the basis of a kinematic model of at least two movable components of the work machine. The kinematic model in particular takes into account all the components involved in the movement of the defined point, and their braking trajectories.

The kinematic model determines the predicted braking trajectory of the defined point based on the definition of how a controller brakes the movable components involved, and on the actual positions and actual speeds of these components. The unit models of the movable components can be constructed from regulation links (in the simplest case PT1 links). The parameterisation of the unit models of the movable components can be based on test or identification journeys, in which the braking behaviour of the respective movable component is detected or studied.

The method can thus include, as a prior step, carrying out at least one test journey of a movable component, during which the associated unit model is parameterised by detecting and plotting actual positions and/or actual speeds and/or actual accelerations of the component.

In a further possible embodiment it is provided that the predicted braking trajectory of the load is determined on the basis of the previously determined predicted braking trajectory of the defined point and on the basis of a physical model. In this case, the physical model takes into account or models in particular the behaviour of the cable in the case of a movement of the work machine or when travelling through the predicted braking trajectory of the defined point, i.e. the physical model takes into account the previously determined predicted braking trajectory of the defined point. Alternatively or in addition, the physical model can take into account the weight of the load and/or a geometry of the load (in particular at least one dimension of the load) and/or a cable length (in particular the length between the cable starting point and load centre of gravity) and/or a wind speed, since these factors can influence the behaviour of the load in the braking process. It is thus determined, on the basis of the physical model, how the load behaves when the previously determined predicted braking trajectory is travelled through during braking. In this case, it is taken into account that a suspended load swings or oscillates during a braking acceleration.

In the simplest case, a model of a mathematical pendulum can be used as the physical model. In this case, the load is preferably modelled as punctiform and the cable without dead load, and influencing by wind is disregarded.

The physical model can receive, as input parameters, the cable length and/or cable speed and/or the current position and/or speed of the load (e.g. relative to the nominal/perpendicular position), as well as the determined predicted braking trajectory of the cable starting point.

In a further possible embodiment it is provided that at least one dimension of the load is combined mathematically with the determined predicted braking trajectory of the load, in order to determine therefrom a predicted collision region within which the load is predicted to move during the braking process. A length or height (for example the height of a lower edge of the load above the ground or an edge length of the load), a surface area (in particular a surface viewed in plan view of the load or the base surface) and/or the volume of the load can be used as a dimension of the load. If, for example, the base surface or the volume of the load is known, a region through which the load will travel can be determined by “setting off on” the predicted braking trajectory taking into account the swinging movements to be expected. The collision region thus determined should therefore be free of obstacles, in order that a collision, in the case of a braking process, can be excluded. Depending on the dimensions of the load that are used, the collision region can be a two-dimensional or three-dimensional region.

In a further possible embodiment it is provided that the determined predicted collision region is compared with environment data of the work machine, in order to identify possible collisions with objects or obstacles. The environment data relate to objects located in an environment of the work machine, wherein the considered environment can be limited to the working region of the work machine or can extend therebeyond. The environment data can be an environment map or map material, wherein in particular the height of the different objects is taken into account. The environment data can be stored in a memory unit or transmitted to a control unit of the work machine (for example wirelessly). Alternatively or in addition it is conceivable that the environment data are generated or adjusted on the basis of sensor measurements or camera recordings of the work machine.

The comparison of the determined predicted collision region with the environment data preferably comprises a check of whether the collision region overlaps with an object in the environment, wherein for preferably only objects of which the height is above a lower edge of the load or a lower edge of the determined predicted collision region are considered for this.

If a collision is identified, a warning can be output and/or automatic intervention in a controller of the work machine is possible, in particular in order to change or to stop a current movement. The warning can be an acoustic and/or optical warning, for example a display on a display unit of the work machine. This warns the operator of the work machine in advance, such that prompt reaction is possible.

In a further possible embodiment it is provided that the predicted braking trajectory of the load takes place assuming a reaction time between a stopping signal and the initiation of braking of the work machine. It is thus assumed, for the prediction of the braking process, that the operator does not react instantaneously, by initiating the braking process, after receiving a notification of a possible collision or a dangerous situation, but rather only after a certain reaction time, which can be in the range of milliseconds or seconds. The longer the assumed reaction time, the longer the predicted braking trajectory and thus the collision region, since the braking process is initiated later.

Preferably, at least two different predicted braking trajectories of the load are determined, based on different assumed reaction times, in order to simulate different scenarios. As a result, cases can also be taken into account in which the operator reacts and starts the braking process only after a longer reaction time, for example on account of tiredness or distraction. This increases the safety and provides better protection against possible collisions.

In this case, in particular a separate predicted collision region is determined for each of the different predicted braking trajectories, and compared with environment data. As a result, different predicted collision regions can be determined for different assumed reaction times. Some of the predicted collision regions thus determined can serve as early warning zones which transmit a warning to the operator early and/or to be able to influence the movement of the work machine early. In the case of an identified possible collision in an early warning zone, instead of an initiated movement stop a change in the current movement can take place, for example braking and/or performing of an evasion movement.

The different predicted collision regions/early warning zones can be displayed to the operator on a display unit in a driver's cab or a mobile control console, for example in different colours.

In a further possible embodiment it is provided that the calculation of the predicted braking trajectory or the above-mentioned predicted collision region is carried out at regular intervals during the operation of the work machine. The prediction can therefore be carried out continuously during the operation, wherein for each movement an associated predicted braking trajectory or an associated predicted collision region (optionally with corresponding early warning zones) is determined. This ensures an effective collision monitoring at any time during operation.

The invention further relates to a work machine comprising a turntable that is rotatable about a vertical axis of rotation, a jib which is connected to the turntable and over which a cable is guided, and a control unit which receives data relating to a current position and/or a current movement of a load suspended on the cable, from at least one sensor of the work machine. The work machine can for example be a stationary or mobile crane, for example a harbour crane for handling containers or other goods.

According to the invention, the work machine comprises a control unit which is configured for carrying out the method according to the invention (i.e. the steps described above, which relate to the control unit or can be carried out thereon). In this case, the same properties and advantages result as for the method according to the invention, and therefore a repeated description is omitted. In particular, all the embodiments and features described above for the method according to the invention also apply for the work machine according to the invention, in any combination.

In a possible embodiment, the work machine comprises an input unit which is connected to the control unit and via which at least one dimension of the suspended load and/or a load type (e.g. container of a particular size) can be input manually. The input unit can be located in a driver's cab of the work machine. Alternatively or in addition, an input via a mobile terminal is conceivable. Alternatively, the at least one dimension can be transmitted to the work machine, in particular wirelessly. It is also conceivable that a plurality of load types and/or dimensions (e.g. container sizes) are stored in a memory unit, and the operator can select the corresponding dimensions and/or the corresponding type.

It is alternatively or additionally conceivable that the dimension of the load is determined by one or more sensors (e.g. camera and/or lidar).

In a further possible embodiment, the work machine comprises an output unit, in particular a monitor, which can e.g. be arranged in a driver's cab of the work machine and/or configured as a mobile terminal. In this case, the control unit is configured to display, in particular to graphically display, a determined predicted braking trajectory of the defined point and/or a calculated predicted braking trajectory of the load and/or a predicted collision region occupied by the load when travelling through the braking trajectory. Different colours can be used for different collision regions/early warning zones.

In a further possible embodiment, the work machine comprises a memory unit on which environment data, relating to objects located in an environment of the work machine, are stored, wherein the control unit has access to the memory unit or comprises it.

The invention furthermore relates to a corresponding computer program product for carrying out the method according to the invention, which comprises commands which, when the program is executed, cause the steps of the above-described method (in any embodiment) relating to the control unit to be carried out by the control unit of the work machine according to the invention. The computer program product can be operated on conventional machine controllers, such that no retrofitting of hardware components is necessary.

### BRIEF DESCRIPTION OF THE FIGURES

Further features, details and advantages of the invention emerge from the following embodiments explained with reference to the figures, in which:

FIG. 1: is a schematic plan view of an embodiment of the work machine according to the invention; and

FIG. 2: is a schematic view of the method according to the invention for collision monitoring of a load.

### DETAILED DESCRIPTION

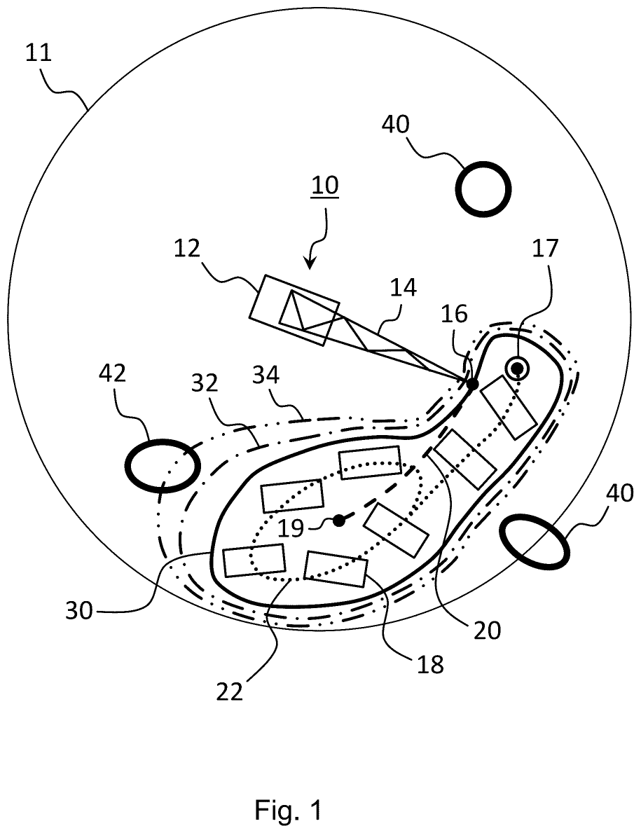

FIG. 1 is a schematic plan view of an embodiment of the work machine 10 according to the invention, comprising a turntable 12 that is rotatable about a vertical axis of rotation, and a jib 14 arranged thereon. A cable for lifting loads (not shown) is guided over the jib tip, wherein the cable starting point is denoted by reference sign 16. The jib 14 can be pivotably mounted on the turntable 12. The work machine 10 has a maximum working range 11, which in this embodiment is circular owing to the rotatability of the turntable 12 about 360°.

A plurality of objects 40, 42 are located at least in part within the working range 11 of the work machine 10 and can therefore in principle represent dangers with respect to a possible collision with a lifted load 18. These objects 40, 42 or obstacles can be other work machines, trees, buildings or the like.

The load 18 lifted in this embodiment has a rectangular base surface (in principle the shape of the load is of course irrelevant and is taken into account in a corresponding manner in the context of the collision method described below). The load 18 can for example be a container or a gripper, and the work machine 10 can for example be a harbour crane.

Owing to the inertia of the work machine 10 and the fact that the load 18 is suspended on a cable, a significant braking path results upon braking of the current machine movement, wherein the load 18 swings and therefore moves in an extended region until it comes to a standstill after some time. This swinging behaviour and the extended braking path are taken into account in the method according to the invention, and therefore a more reliable warning of collisions and ultimately a more effective collision prevention can be achieved.

The method can be carried out by a control unit of the work machine 10, which can for example be the machine controller. In this case, the control unit determines, in a first step, a predicted braking trajectory 20 of a defined point of the work machine 10, which, in the embodiment shown, is a cable starting point 16 on the jib tip.

The predicted braking trajectory 20 is a projected trajectory or movement path of the cable starting point 16, which in particular results assuming that the operator of the work machine 10 brakes a current movement of the work machine 10 to standstill. In this case, the cable starting point 16 moves along the predicted braking trajectory 20 until it comes to a standstill at a stopping point 19. In order to determine the predicted braking trajectory 20 of the cable starting point 16, it is possible to proceed from the assumption that a certain reaction time t_{R} elapses between a notification to the operator, leading to the decision to initiate braking, and the actual initiation of the braking process. It can furthermore be assumed that the braking takes place by means of at least one braking device and with maximum braking force, in order to minimise the braking path. Alternatively, the braking can take place without a braking device, by reducing the drive speed(s) to zero. The at least one braking device can be a brake provided in addition to the drive, or the drive itself. Depending on the component, braking can take place via the drive or via an additional brake.

Preferably the braking (reduction of the target speed) takes place on the basis of a defined braking function, which can be defined in a controller or the control unit.

The movement of the cable starting point 16 can be made up of a plurality of individual movements (e.g. rotation of the turntable 12 and pivot movement of the jib 14), such that a plurality of drives (e.g. rotary drive and luffing cylinder) are involved. In order to determine the predicted braking trajectory 20 of the cable starting point 16, therefore a predicted braking trajectory is determined for the units involved, i.e. for each of the movable components or drives involved in the current machine movement. If just one single movement is involved, the predicted braking trajectory of the corresponding component (e.g. in the case of a pure rotational movement of the turntable 12, cf. FIG. 1) can simply be converted into the predicted braking trajectory 20 of the cable starting point 16 or can correspond thereto.

The predicted braking trajectory 20 of the cable starting point 16 is determined from the projected braking trajectories of the individual units or components, preferably by means of a kinematic model.

The calculation of the predicted braking trajectory 20 of the cable starting point 16 is preferably based on the following:
a definition of how the controller of the work machine 10 (this can be the mentioned control unit) reduces the target speed of the actuators upon stopping;
the current speed and the current position of the unit, which are detected via corresponding sensors and made available to the control unit; and
a model of the unit, which predicts the braking behaviour based on the above-mentioned parameters. These unit models can be constructed e.g. on regulation links (in the simplest case PT1). The parameterisation of the unit models is based in particular on test or identification journeys, in which the braking behaviour of the respective unit is studied.

The kinematic model is in particular defined by static geometry parameters of the work machine 10, such as the jib length and/or the joint positions and/or the joint speeds of the slewing gear, luffing mechanism and/or the cable length. These positions and speeds are preferably converted into the coordinate system of the respective actuator, in order to be able to use the above-mentioned unit model for the dynamic braking behaviour. Thus, based on the example of the luffing mechanism, it is possible to determine the angle of the jib 14 via a rotary encoder, but the movement thereof is carried out and correspondingly modelled by a hydraulic cylinder. With the aid of the calculated braking trajectories per unit or per movable component, preferably the position and speed of the cable starting point 16 is calculated for each time step, via the forwards kinematics.

The kinematic model can make one or more of the following simplified assumptions:
crane structure as rigid body;
load as point mass;
cables are massless and/or rigid;
only a small cable starting angle.

The above comments relating to the unit models and to the kinematic model apply irrespective of the specific embodiment of the work machine 10 or the movable components involved.

In the embodiment of FIG. 1, a predicted braking trajectory 20 of the cable starting point 16 is shown as a dashed line. In this case, a rotational movement of the work machine 10 is braked. Upon initiation of the braking process, the load is at the indicated starting position 17 (this is offset outwards/to the rear, relative to the cable starting position 16, on account of the rotational movement).

During the braking process, the load 18 moves along its own movement path 22 and subsequently swings for a certain time around the stopping position 19 of the cable starting point 16. This process is preferably modelled on the basis of the determined predicted braking trajectory 20 of the cable starting point 16 and based on a physical model. For this purpose, preferably the current cable length between the cable starting point 16 and load 18 and/or the weight of the load 18 and/or a speed and/or an acceleration of the work machine 10 can be taken into account. Further input parameters are of course possible. Some or all of the mentioned variables can be detected via corresponding sensors of the work machine 10 and transmitted to the control unit (the weight of the load 18 can for example be determined via a pressure measurement in at least one hydraulic cylinder and/or the detection of a cable force; the current cable length can be detected e.g. via a rotary encoder of a cable winch).

Alternatively or in addition, parameters can be able to be input manually by the operator, via an input unit, for example the weight of the load 18 or the selection of a load type, for which a particular weight is already stored.

In FIG. 1, the predicted braking trajectory 22 of the load 18 resulting therefrom is shown as a dotted line. In this case, however, the complete predicted braking trajectory 22 as far as standstill of the load 18 is not shown (this would spiral as far as the stopping position 19), but rather only a portion. For some of the positions along the predicted braking trajectory 22, the load 18 is shown. It can be seen that this can rotate about a vertical axis during the braking process.

The physical model preferably furthermore takes into account a geometry of the load 18, in particular its base surface and preferably its volume or all the dimensions in three-dimensional space. Alternatively or in addition, the height of a lower edge of the load 18 above the ground can be taken into account, which can result from a current cable length and the geometry of the load 18. Likewise, it is also possible for only the base surface and the lower edge height of the load 18 to be taken into account.

The geometry of the load 18 can optionally be able to be input by the operator by means of an input unit, or be determinable by input/selection of a load type (e.g. a particular container size). If the load 18 is a tool (for example a gripper), then its geometry can be stored in the control unit, since it does not change. It is alternatively or additionally conceivable to detect the geometry and/or mass of the load 18 via corresponding sensors.

On the basis of the determined predicted braking trajectory 22 of the load 18 and the geometry of the load 18, the physical model calculates a surface area or a volume which the load 18 is predicted to occupy, on account of its dynamic oscillation behaviour, when travelling through the predicted braking trajectory 22. This results in a predicted collision region within which a collision with objects may occur in the case of an assumed abrupt braking, the height of which objects is below the lower edge of the load 18.

This resulting collision region depends on the assumed reaction time t_{R}. FIG. 1 shows three different predicted collision regions 30, 32, 34. A first predicted collision region 30, the edge of which is shown by a solid line, can be based on an average assumed reaction time t_{R1}. A second predicted collision region 32, the edge of which is shown by a dot-dashed line, is based on a longer assumed reaction time t_{R2}, while a third predicted collision region 34, the edge of which is shown by a dot-dashed (two-dash) line, is based on an even longer assumed reaction time t_{R3} (i.e. t_{R1}<t_{R2}<t_{R3}).

These predicted collision regions 30, 32, 34 (i.e. their surface areas or volumes) are preferably compared, for possible obstacles, with environment data (e.g. a representative map of the machine environment). The environment data can be stored on a memory unit of the work machine 10 or in the control unit, and/or be transmittable to the work machine 10 from an external computing unit (for example wirelessly).

In FIG. 1 three possible obstacles 40, 42 (i.e. objects located at least in part within the working range 11 and the height of which is in particular above the lower edge of the load 18) are shown. Two objects 40 do not overlap with any of the predicted collision regions 30, 32, 34. However, one of the objects 42 is located within the third predicted collision region 34, such that a collision could occur here.

The second and third predicted collision regions 32, 34 can function as early warning zones which can warn the operator in good time of a collision. If it is assumed that the reaction times on which the early warning zones 32, 34 are based are above typical reaction times t_{R2}, t_{R3}, the operator can still brake in good time by initiating braking, such that no collision with the object 42 occurs. In a manner deviating from FIG. 1, more or fewer early warning zones and/or larger or smaller early warning zones can also be determined.

The determined predicted collision regions 30, 32, 34 can serve for outputting warnings to an operator in good time, such that said operator can react early (assistance system). Alternatively, the described method could be used in the context of an autonomous machine controller.

Alternatively or in addition to a warning to the operator in the case of an identified possible collision, an automatic intervention into the machine controller can also take place (e.g. in order to immediately initiate braking or in order to change a current machine movement and thus possibly evade an obstacle if braking in good time is no longer possible).

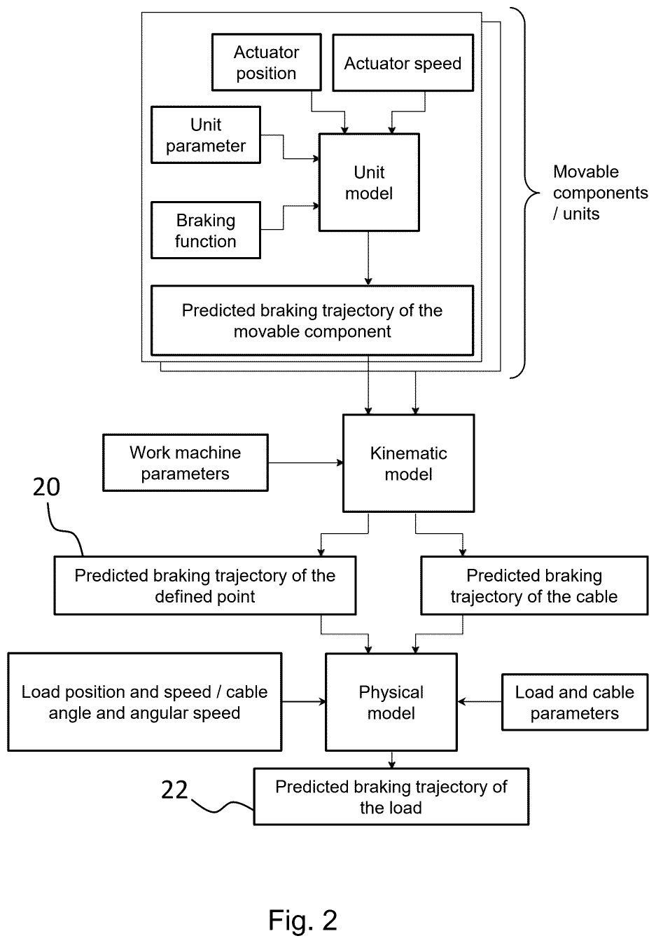

FIG. 2 schematically shows an embodiment of the method according to the invention and the various influencing variables/steps.

It can be seen that for each component/unit involved in the movement of the load 18, a predicted braking trajectory is calculated on the basis of a unit model. Each of the unit models can receive, as input parameters, the current unit or actuator position detected via sensors, the current unit or actuator speed detected via sensors, further unit parameters (e.g. the geometry and/or mass of the movable component) and/or an associated defined braking function (i.e. a definition of how the controller reduces the target speed of the unit or actuator upon stopping).

A kinematic model calculates a predicted braking trajectory of the defined point 20, in particular of the cable starting point 16, on the basis of the predicted braking trajectories of the units or movable components and further parameters of the work machine 10.

On the basis of this calculated braking trajectory and further parameters relating to the suspended load 18 (in particular its dimensions and/or mass) and to the cable (in particular its cable length between the load centre of gravity and cable starting point 16), a physical model calculates a predicted braking trajectory of the load 22. In this case, the physical model takes into account the current load position and load speed, and/or the current cable position and cable angular speeds.

Furthermore, it can be provided that the kinematic model determines a predicted braking trajectory of the cable, and this is also taken into account by the kinematic model. This can be the trajectory of the cable length between the defined point (in particular cable starting point 16) and the cable end, i.e. the cable length over the time until standstill of all units.

### LIST OF REFERENCE SIGNS

10 work machine
11 working range
12 turntable
14 jib
16 cable starting point
17 starting position of the load
18 load
19 stopping position
20 predicted braking trajectory of the defined point
22 predicted braking trajectory of the load
30 predicted collision region
32 predicted collision region
34 predicted collision region
40 object outside the collision region
42 object within the collision region

1. Method for collision monitoring of a load (18) which is fastened to a cable of a work machine (10), in particular a crane, wherein the work machine (10) has a turntable (12) that is rotatable about a vertical axis of rotation, a jib (14) which is connected to the turntable (12) and over which the cable is guided, and at least one sensor for detecting a current position and/or movement of at least one movable component of the work machine (10),
characterised in that
a predicted braking trajectory (20) of a defined point of the work machine (10) is determined based on the sensor data, and a predicted braking trajectory (22) of the load (18) is calculated on the basis of the determined braking trajectory (20) of the defined point and a computational model.

2. Method according to claim 1, wherein the defined point is a point on the jib (14), in particular a cable starting point (16), wherein the cable starting point (16) is preferably located on a jib head.

3. Method according to either claim 1 or claim 2, wherein the predicted braking trajectory (20) of the defined point is determined on the basis of at least one predicted braking trajectory of a movable component of the work machine (10), preferably on the basis of a combination of at least two predicted braking trajectories of different movable components of the work machine (10).

4. Method according to any of the preceding claims, wherein the predicted braking trajectory (20) of the defined point is determined on the basis of a kinematic model of the work machine (10), in particular on the basis of a kinematic model of at least two movable components of the work machine (10).

5. Method according to any of the preceding claims, wherein the predicted braking trajectory (22) of the load is determined on the basis of a physical model, wherein the model in particular takes into account the behaviour of the cable during a movement of the work machine (10) and/or the weight of the load (18) and/or a geometry of the load (18) and/or a cable length and/or a wind speed.

6. Method according to any of the preceding claims, wherein at least one dimension of the load (18), preferably a height, a surface area and/or the volume of the load (18), is combined computationally with the determined predicted braking trajectory (22) of the load, in order to determine therefrom a predicted collision region (30, 32, 34) which the load (18) occupies when travelling through the braking trajectory (22).

7. Method according to the preceding claim, wherein the determined predicted collision region (30, 32, 34) is compared with environment data of the work machine (10), wherein the environment data relate to objects (40, 42) located in an environment of the work machine (10), wherein the comparison preferably includes a check of whether the determined predicted collision region (30, 32, 34) overlaps with an object (40, 42) in the environment, wherein in the case of a determined predicted collision a warning is output and/or there is automatic intervention in a control of the work machine (10).

8. Method according to any of the preceding claims, wherein the predicted braking trajectory (22) of the load (18) takes place assuming a reaction time between a stop signal and the introduction of braking of the work machine (10), wherein preferably at least two different predicted braking trajectories (22) of the load are determined based on different assumed reaction times, and wherein in particular a predicted collision region (30, 32, 34) is determined for each of the different predicted braking trajectories (22), and compared with environment data.

9. Method according to any of the preceding claims, wherein the calculation of the predicted braking trajectory (22) of the load (18) is carried out at regular intervals during the operation of the work machine (10).

10. Work machine (10), in particular crane, comprising a turntable (12) that is rotatable about a vertical axis of rotation, a jib (14) which is connected to the turntable (12) and over which a cable is guided, and a control unit which receives data relating to a current position and/or movement of a load (18) suspended on the cable, from at least one sensor of the work machine (10),
characterised in that
the control unit is configured to carry out the method according to any of the preceding claims.

11. Work machine (10) according to the preceding claim, comprising an input unit which is connected to the control unit and via which at least one dimension, in particular a volume, of the suspended load (18) and/or a load type can be input manually.

12. Work machine according to either claim 10 or claim 11, comprising an output unit, in particular a monitor, wherein the control unit is configured to display, in particular to graphically display, a determined predicted braking trajectory (20) of the defined point and/or a calculated predicted braking trajectory (22) of the load (18) and/or a predicted collision region (30, 32, 34) occupied by the load (18) when travelling through the braking trajectory (22).

13. Work machine according to any of claims 10 to 12, comprising a memory unit on which environment data, relating to objects (40, 42) located in an environment of the work machine (10), are stored, wherein the control unit has access to the memory unit or comprises it.

14. Computer program product comprising commands which, when the program is executed, cause the steps of the method according to any of claims 1 to 9 to be carried out by the control unit of the work machine (10) according to any of claims 10 to 13.
